(19) United States
(12) Patent Application Publication
(10) Pub. No.: US 2011/0202475 A1
(43) Pub. Date: Aug. 18, 2011

(54) METHODS AND SYSTEMS FOR PROVIDING AN ANTI-BENCHMARK PORTFOLIO

(76) Inventor: Yves CHOUEIFATY, Paris (FR)

(21) Appl. No.: 13/095,213

(22) Filed: Apr. 27, 2011

Related U.S. Application Data
(63) Continuation-in-part of application No. 11/821,261, filed on Jun. 22, 2007, now Pat. No. 7,958,038.
(60) Provisional application No. 60/816,276, filed on Jun. 22, 2006.

(51) Int. Cl. G06Q 40/00

(52) U.S. Cl. 705/36 R

(57) ABSTRACT

Methods and systems are described regarding creating a portfolio of securities involving a step of maximizing a diversification ratio represented by a quotient having as a numerator a measure of a weighted average risk characteristic of a group of securities and as a denominator a measure of an overall risk characteristic of the portfolio.

### CROSS-REFERENCE TO RELATED APPLICATIONS

This application is a continuation-in-part of U.S. patent application Ser. No. 11/821,261, filed Jun. 22, 2007, which claims the benefit of U.S. Provisional Patent Application No. 60/816,276, filed Jun. 22, 2006, each of which are incorporated herein by reference.

### INTRODUCTION

There is evidence that market portfolios are not as efficient as assumed in the Capital Asset Pricing Model (CAPM). The general idea behind CAPM is that investors need to be compensated in two ways: time value of money and risk. The time value of money is represented by the risk-free rate in the formula and compensates the investors for placing money in any investment over a period of time. The other half of the formula represents risk and calculates the amount of compensation the investor needs for taking on additional risk. This is calculated by taking a risk measure (beta) that compares the returns of the asset to the market over a period of time and to the market premium. However, while risk and correlation are measures that have some consistency over time, returns are so unpredictable that there is little reason for the CAPM market portfolio to be efficient.

### SUMMARY OF THE INVENTION

The inventors developed a method and system for creating and managing a portfolio of securities (for instance, equities or bonds) that yields an improved return-to-risk ratio with lower volatility relative to the CAPM market portfolio and other known portfolio management techniques and indices.

In accordance with the methods described herein, a uniquely identified portfolio with maximum diversification (“Anti-Benchmark”) is created by selecting securities from a first portfolio (“benchmark”) whose investment universe is a given predefined universe of securities (for instance the universe of a stock index) and maximizing diversification of the second portfolio based upon a “diversification ratio” which is represented by the ratio of a weighted average risk characteristic of the individual securities and an overall risk characteristic of the portfolio. The Anti-Benchmark portfolio optimally captures the available risk premium and usually provides better expected return and lower expected volatility compared to the benchmark.

In another aspect, a computer program stored on a computer readable medium is provided which, when executed by a computer, provides an Anti-Benchmark portfolio for which the diversification ratio is maximized.

In yet another aspect, a system is provided which is adapted to automatically process data regarding a benchmark portfolio so as to provide an Anti-Benchmark portfolio for which the diversification ratio is maximized.

In yet another aspect, the number of degrees of freedom for a given portfolio, or for a given Universe of assets, is determined based upon information obtained by determining the diversification ratio for the given portfolio or the Anti-Benchmark portfolio having the given Universe of assets as investment universe.

### BRIEF DESCRIPTION OF THE DRAWINGS

FIG. 1 depicts Anti-Benchmark pushing closer to the efficient frontier.

FIG. 2 depicts preferred back test methodology.

FIG. 3 provides an embodiment of Anti-Benchmark portfolio construction.

### DETAILED DESCRIPTION

Only non-diversifiable risk being rewarded by a risk premium, an embodiment of the Anti-Benchmark product aims at defining optimal portfolios in a mean-variance framework. Provided that diversification in publicly available benchmarks (indices) is not optimal, the Anti-Benchmark, by maximizing diversification, offers an investor the opportunity to invest in a product having a return similar to—and a volatility lower than—the corresponding benchmark. This product will assist investors who have large overweights in the benchmark constituents, and therefore seek diversification.

A tangible result of the product is that, inter alia, the combination of the Anti-Benchmark with a benchmark will have a higher expected return to risk ratio than the benchmark itself.

The Anti-Benchmark will have low correlation, and potentially lower volatility and higher Sharpe ratio compared to standard market cap weighted indices. The Sharpe ratio was developed to measure risk-adjusted performance, and is calculated by subtracting the risk-free rate from the rate of return for a portfolio and dividing the result by the standard deviation of the portfolio returns. The Sharpe ratio indicates whether the returns of a portfolio are due to smart investment decisions or a result of excess risk. The greater a portfolio's Sharpe ratio, the better its risk-adjusted performance has been.

The Anti-Benchmark offers the flexibility of being tailored to any benchmark, and can be utilized to increase the Sharpe ratio or decrease the total risk for any client's long-only beta exposure. Beta is a measure of the volatility of a portfolio in comparison to the market as a whole. Beta may be thought of as the tendency of a portfolio's returns to respond to swings in the market. A beta of 1 indicates that the portfolio's price will tend to move with the market. A beta of less than 1 means that the security will be less volatile than the market. A beta of greater than 1 indicates that the security's price will be more volatile than the market. For example, if a stock's beta is 1.2, it's theoretically 20% more volatile than the market.

Combining Anti-Benchmark with an Index Portfolio will provide clients with a higher risk premium and lower expected total risk. An Anti-Benchmark portfolio created according to the invention offers clients a way to increase their diversification using a scalable long-only approach, and will alleviate some of the pressure to search for scalable diversifying return from non-traditional sources.

Biasing a long-only beta exposure towards lower average pair-wise correlation of securities' returns provides better diversification than a market cap weighted benchmark does. The effect of diversification managed in this way is that the risk premium can be kept and most of the risk associated with common factor and stock-specific risk can be diversified away. The investor will be left with the full available risk premium of the market index, but with significantly less of the bias toward lower compounded returns that can result from using market capitalization weighted benchmarks.

Anti-Benchmark is easy to understand, transparent, and in an embodiment a good replacement for other core strategies for gaining market beta exposure. Since alphas are not predicted, it is less track-record sensitive than many other quantitative portfolio styles. Alpha is a measure of performance on a risk-adjusted basis. Alpha takes the volatility (price risk) of a portfolio and compares its risk-adjusted performance to a benchmark. The excess return of the portfolio relative to the return of the benchmark is the portfolio's alpha. Reliance on theory to provide the strategy's methodology means that the research is not susceptible to the data mining concerns often associated with other quantitative approaches.

The inventors discovered that designing portfolios with the deliberate intent of having low correlation to indices within acceptable risk management constraints leads to lower risk portfolios without giving up on expected returns over multi-year holding periods. A portfolio with maximum diversification can capitalize on the inefficiencies of securities valuation without the need to predict alphas to determine stock selection. Anti-Benchmark is a tool that can be used to gravitate toward maximum diversification, and back testing to date indicates that positive alpha is another potential benefit of the Anti-Benchmark process.

In an embodiment, the Anti-Benchmark's Diversification ratio of said first portfolio allows for measuring the total number of degrees of freedom available to said first portfolio. (“Anti-Benchmark Degrees of freedom of the Portfolio”). Said Anti-Benchmark Degrees of freedom is defined as the square of said Anti-Benchmark Diversification Ratio of said first Portfolio

In an embodiment, the Anti-Benchmark's Diversification ratio allows for measuring the total number of degrees of freedom available in the universe (“Anti-Benchmark Degrees of freedom of the Universe”) of predefined securities included in “the benchmark”. Said Anti-Benchmark Degrees of freedom is defined as the square of said the Anti-Benchmark Diversification Ratio of said Anti-Benchmark Portfolio

Anti-Benchmark may be a purely quantitative active portfolio management system that requires no human intervention during active security selection once screens of the universe for issues such as Merger & Acquisition activity and corporate actions have been implemented. The preferred starting point in the process is an investor universe screened for investibility and for suitability for the model. Correlation and covariances may also be utilized to select the securities to be utilized in formulating the Anti-Benchmark, and final weightings are determined by maximizing the diversification ratio. The system preferably employs risk characteristics as the sole inputs to the maximization process. Optimization preferably is performed on a periodic or occasional basis, but actual rebalancing is dependent on the deviation from optimal over time.

In another embodiment, investment constraints on the portfolio are built in by setting a maximum level of concentration in any given name. It is not necessary to limit the tracking error (standard deviation of the differences in daily returns) to an index. Volatility also is not necessarily constrained, but, due to the bias for low correlations, is normally lower than the index volatility. If Merger & Acquisition activity or other market information not explicitly handled by the model has a material impact on any of the holdings, it may be dealt with on a case by case basis based on the experience of the investment team.

In another embodiment, investment constraints on the portfolio are built in by setting a maximum level of concentration in any given name. An explicit attempt is made to constrain the tracking error, as well as the overall volatility of the portfolio, by using standard portfolio optimization techniques.

Positions preferably are monitored on a daily basis using risk management tools. Corporate actions and market information preferably are analyzed for impact on the expected returns, and actions are taken if appropriate based on size of the risk and impact on the overall portfolio. In almost all cases changes to the portfolio weightings are implemented through optimization of the overall portfolio.

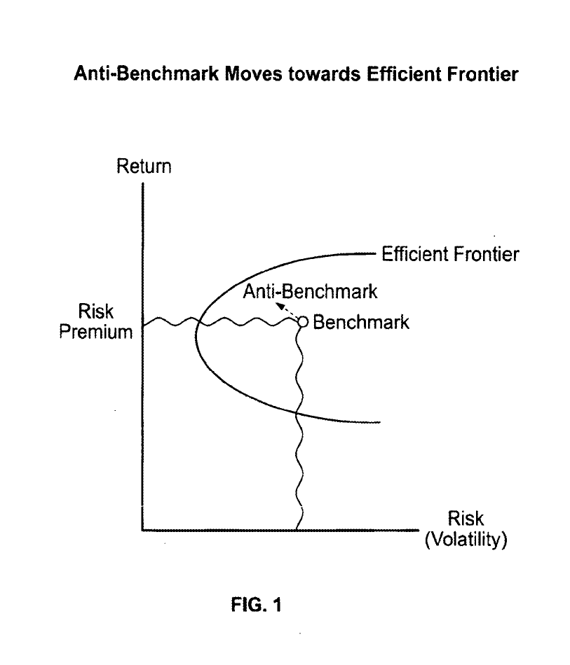

Attributes and Advantages of the Various Embodiments
Anti-Benchmark is a quantitative method intended to reconstruct beta to provide significant diversification within a core security allocation to the extent that it can be considered a separate asset class for purposes of asset allocation.
The strategy will have low average pair wise correlation, and potentially lower volatility and higher Sharpe Ratio compared to standard market cap weighted indices.
The strategy offers the flexibility of being tailored to any investor benchmark, and can be utilized to increase the Sharpe ratio or decrease the total risk for any investor's long-beta exposure.
Combining Anti-Benchmark with an Index Portfolio can provide investors essentially the same risk premium with lower total risk.
This product will alleviate some of the pressure in the search for scalable diversifying return through alternative asset class products.
The number of independent risk factors available to a given portfolio can be determined.
The number of independent risk factors available in a given universe of assets can be determined
Anti-Benchmark pushes closer to the Efficient Frontier (see FIG. 1).
Anti-Benchmark through diversification is a more efficient portfolio than market cap weighted indices.
Combining Anti-Benchmark with an Index tracking portfolio provides a significant diversification.
Adding Anti-Benchmark to an investor's asset mix delivers a higher overall reward to risk ratio.
Determining the “Anti-Benchmark Number of Degrees of Freedom of a Portfolio” allow investors to estimate how many independent risk factors are represented in their portfolio. This is another important criteria for choosing between possible portfolios. The greater the number of independent risk factors carrying a positive risk premium in a portfolio, the greater is the diversification opportunity available to the portfolio.
Determining the “Anti-Benchmark Number of Degrees of Freedom of the Universe” allow investors to estimate how many independent risk factors are available for investment in a given universe of assets. This is another important criteria for choosing between possible investment universes. The greater the number of independent risk factors carrying a positive risk premium, the greater the diversification opportunity is in the universe.

In a preferred embodiment, the method comprises: (a) acquiring data regarding a first group of securities in a first portfolio; (b) based on said data and, optionally, on risk characteristics of said first group of securities, identifying a second group of securities to be included in a second portfolio; and (c) determining holdings to comprise the Anti-Benchmark portfolio based on one or more portfolio optimization procedures performed on the second portfolio. The Anti-Benchmark portfolio preferably is generated based upon a maximization of the diversification ratio representing the ratio of a weighted average risk characteristic of the individual securities and the actual risk of the portfolio. Risk characteristics used in the diversification ratio may include volatilities of the securities or of the portfolio. In another embodiment, the method further comprises (d) determining the number of degrees of freedom available in the first or second portfolio by calculating the square of the diversification ratio of the first or second portfolio, respectively.

The criteria for selection of securities to be included in the second portfolio may include correlations and volatilities of the securities' daily returns, investor preferences or any other criteria. The second portfolio may include all or fewer than all of the securities of the first portfolio. In one aspect, securities within the defined universe may be run through a program that computes correlations and volatilities of securities' daily returns. Once the correlations and volatilities are determined, a second portfolio is selected. Depending on the benchmark universe, this second portfolio could be, for example, from 10-100 stocks, and will have the investment objective of capturing risk premium to achieve a better return to risk ratio in a selected universe of securities.

In various embodiments: the step of identifying may be based on calculating a correlation matrix and a covariance matrix; the securities contained in the first portfolio may be the same as the securities contained in the second portfolio; the step of maximizing may comprise maximizing a quotient whose numerator is an inner product of a row vector whose components are said holdings in said second portfolio and a column vector of one or more risk characteristics, such as volatilities, associated with said holdings in said second portfolio, and whose denominator may be a square root of a scalar formed by an inner product of said row vector of said holdings of said second portfolio and a product of said covariance matrix and a column vector of said holdings of said second portfolio, with the maximizing accomplished by variation of the respective weights of said holdings of said second portfolio; and the step of maximizing may comprise producing a combined portfolio from portions of the first portfolio and portions of the second portfolio, and maximizing the diversification ratio of the combined portfolio.

Preferably, the Anti-Benchmark portfolio provides a full risk premium available in the securities of said second portfolio. Also preferably, the Anti-Benchmark portfolio provides a higher expected return and a lower expected volatility than the first portfolio. The Anti-Benchmark portfolio may also provide a higher Sharpe ratio than the first portfolio.

The method may further comprise optimizing the second portfolio on a periodic basis. In another embodiment, the method may further comprise transforming the second portfolio into an equivariant portfolio, and manipulating and back-transforming the equivariant portfolio via a Choueifaty Synthetic Asset Transformation, as described more fully below.

In another aspect, the invention comprises software for performing the steps described above, and in another aspect, the invention comprises one or more computer systems operable to perform those steps. Both the software and the computer system will be apparent from the description of the various embodiments of the method provided herein.

Universe and Benchmark Selection for Certain Embodiments
Universe can be any set of securities large enough to determine a diversified portfolio.
Benchmark selection is preferably similar to the universe or more narrow.
If a benchmark is broadly defined and includes illiquid securities, it is preferable to apply a liquidity screen to the Universe.

Regression Analysis Computations for Certain Embodiments
Computations are based upon multiple years of weekly price data.
No attempt to adjust or smooth the data for time or outliers.
Cross-asset correlations are considered as well as those against the benchmark.

Stock Selection and Optimization for Certain Embodiments
Mean-Variance style analysis chooses a basket of securities which attempts maximum diversification.
Initial analysis is run using an unconstrained optimization.

Exemplary Constraints
10/40:
   no more than 10% per name
   all holdings above 5% represent no more than 40% of the portfolio
No explicit attempt to constrain by industry or common factors such as size, value/growth
Liquidity constraints on the portfolio permitted to allow for greater capacity
Tracking error as well as volatility constraints may be permitted, for example, in certain universes where correlation and volatilities are not independent.

### Example 1

Let (X₁, X₂, . . . , X_{N}) be a universe of assets. Let V be the covariance matrix of these assets, C the correlation matrix, and B=(W_{b1}, W_{b2}, . . . , W_{bN}), with

$${\sum }_{i = 1}^{N} {W}_{bi} = 1 ,$$

be a given benchmark portfolio composed of these assets.

Let

$$\sum = [ \begin{matrix}{σ}_{1} \\ {σ}_{2} \\ ⋮ \\ {σ}_{N}\end{matrix} ]$$

be the vector of risk characteristics of returns associated with the assets. In one embodiment, the risk is measured by the assets' volatilities.

Definition of a Risk Efficient Portfolio

A goal is to construct a portfolio P=(Wₚ₁, Wₚ₂, . . . , W_{pN}), with

$${\sum }_{i = 1}^{N} {W}_{pi} = 1 ,$$

composed of the same assets as the benchmark and that maximizes a ratio R, the Anti-Benchmark diversification ratio, where R is given by

$$R = \frac{P Σ}{\sqrt{PVP}}$$

R can then be maximized with respect to variation of P.

$$\begin{matrix}Max \\ P\end{matrix} R = \begin{matrix}Max \\ P\end{matrix} \frac{P Σ}{\sqrt{PVP}} \qquad ( 1 )$$

This enables maximization of diversification.

Certain embodiments may include constraints on P during the maximization.

If stock returns are proportional to their risk characteristics of returns, then maximizing R is equivalent to maximizing the Sharpe ratio, E(P)=PΣ and

Max R is equivalent to

$$Max \frac{E ( P )}{\sqrt{PVP}}$$

Let us then build synthetic assets (X′₁, X′₂, . . . , X′_{N}), with

$${X}_{i}^{′} = \frac{{X}_{i}}{{σ}_{i}} + ( 1 - \frac{1}{{σ}_{i}} ) \$ ,$$

where $ is a risk free asset. For simplification, it may be assumed that $ has a return of zero. This is the Choueifaty Synthetic Asset Transformation.

Then the risk characteristics of returns σ′ᵢ, of X′ᵢ, is equal to 1, and

$${\sum }^{′} = [ \begin{matrix}1 \\ 1 \\ ⋮ \\ 1\end{matrix} ]$$

since X′ᵢ, have a normalized risk characteristics of return of 1.

(1) then becomes (2)

$$Max \frac{{P}^{′} {Σ}^{′}}{\sqrt{{P}^{′} {V}^{′} {P}^{′}}} ,$$

where P′ is a portfolio composed of the synthetic assets and V′ the covariance matrix of the synthetic assets.

(2) is then equivalent to

$$Max \frac{1}{\sqrt{{P}^{′} {V}^{′} {P}^{′}}}$$

Since all X′ᵢ have a normalized volatility of 1, V′ is equal to the correlation matrix C of our initial assets, so (2) is equivalent to

(3) Min P′CP′

When trying to build a real portfolio, it is preferable to reconstruct synthetic assets by holding some real assets plus some cash. If W=(W₁, W₂, . . . , W_{N}), denotes the optimal weights for (3), then the optimal portfolio of real assets will be

$${P}_{opt} = ( \frac{{W}_{1}}{{σ}_{1}} , \frac{{W}_{2}}{{σ}_{2}} , … , \frac{{W}_{N}}{{σ}_{N}} , ( 1 - {\sum }_{i - 1}^{N} \frac{{W}_{i}}{{σ}_{i}} ) \$ )$$

This step is the Choueifaty Synthetic Asset Back-Transformation.

We will call this optimal Anti-Benchmark portfolio the risk efficient portfolio.

Definition of an Embodiment of the Anti-Benchmark

Let's now suppose that we try to bring some improvement of the R ratio in an indexed portfolio, equivalent to the benchmark B in terms of risk/return characteristics.

We will add a proportion (scalar multiple) μ of a new portfolio P designed to optimize

$$Max \frac{( μ P + ( 1 - μ ) B ) Σ}{\sqrt{( μ P + ( 1 - μ ) V ( μ P + ( 1 - μ ) B )}} \qquad ( 4 )$$

If we make the same assumption (1) on security returns, and the same use of synthetic assets, we can define B as a benchmark of synthetic assets plus some cash:

$$B = ( {w}_{b 1} {σ}_{1} , {w}_{b 2} {σ}_{2} , … , {w}_{bN} {σ}_{N} , ( 1 - {\sum }_{i = 1}^{N} {w}_{i} {σ}_{i} ) ) .$$

Let B′ denote the non-cash part of B.

(4) is equivalent to

$$Max \frac{μ + ( 1 - μ ) {B}^{′} Σ}{\sqrt{( μ {P}^{′} + ( 1 - μ ) {B}^{′} ) V ( μ {P}^{′} + ( 1 - μ ) {B}^{′} )}}$$

and equivalent to

(5) Min μ²P′CP′+(1−μ)²B′CB′+2μ(1−μ)P′CB′ since the numerator is constant.

(1−μ)²B′CB′ also is a constant, so (5) is equivalent to

(6) Min μ²P′CP′+2μ(1−μ)P′CB′

Since μ is supposed to be small at the beginning (market cap weighted benchmarks are dominant), we will minimize the second term of (6), and our optimization program becomes

(7) Min P′CB′

Portfolios P and P′ derived from equations (1), (3) and (7) all comprise Anti-Benchmark Portfolios with respect to any selected universe of securities, including but not limited to any selected benchmark

### Example 2

Let (X₁, X₂, . . . , X_{N}) be a universe of assets. and B=(W_{b1}, W_{b2}, . . . , W_{bN}), with

$${\sum }_{i = 1}^{N} {W}_{bi} = 1 ,$$

be a given benchmark portfolio composed of these assets.

Let

$$\sum = [ \begin{matrix}{σ}_{1} \\ {σ}_{2} \\ ⋮ \\ {σ}_{N}\end{matrix} ]$$

be the vector of risk characteristics of returns associated with the assets.

Definition of a Risk Efficient Portfolio

A goal is to construct a portfolio P=(Wₚ₁, Wₚ₂, . . . , W_{pN}), with

$${\sum }_{i = 1}^{N} {W}_{pi} = 1 ,$$

composed of the same assets as the benchmark and that maximizes a ratio R, the Anti-Benchmark diversification ratio, where R is given by:

$$R = \frac{P Σ}{RM ( P )}$$

Where RM(P) represents the total risk of the portfolio, with RM representing a positive risk measure.

R can then be maximized with respect to variation of P.

$$\begin{matrix}Max \\ P\end{matrix} R = \begin{matrix}Max \\ P\end{matrix} \frac{P Σ}{RM ( P )} \qquad ( 1 )$$

Certain embodiments may include constraints on P during the maximization.

This enables maximization of diversification, with the optimization carried out as in Example 1 using the Choueifaty transformation.

### Example 3

Let (X₁, X₂, . . . , X_{N}) be a universe of uncorrelated risk factors. Let V be the covariance matrix of these assets, C the correlation matrix, and B=(W_{b1}, W_{b2}, . . . , W_{bN}), with

$${\sum }_{i = 1}^{N} {W}_{bi} = 1 ,$$

be a given portfolio.

Let

$$\sum = [ \begin{matrix}{σ}_{1} \\ {σ}_{2} \\ ⋮ \\ {σ}_{N}\end{matrix} ]$$

be the vector of volatilities associated with the factors.

Anti-Benchmark Number of Degrees of Freedom (N) of a Portfolio B

The Anti-Benchmark diversification ratio of the portfolio B is given by:

$$R = \frac{B Σ}{\sqrt{BVB}}$$

As the factors are uncorrelated, an efficient portfolio such as the Anti-Benchmark will allocate the same amount of risk on all assets, and will have weights that are inversely proportional to volatilities with proportionality coefficient k. Also, the covariance matrix of the factors contains zeros on all off diagonal elements, and the square of the assets volatilities on the diagonal. The Anti-Benchmark diversification ratio of the efficient portfolio B will simplify to:

$$R = \frac{{\sum }_{i = 1}^{N} ( k / {σ}_{i} ) {σ}_{i}}{\sqrt{{\sum }_{i = 1}^{N} {( k / {σ}_{i} )}^{2} {σ}_{i}^{2}}} = \sqrt{N}$$

As a result, the square of the Anti-Benchmark Diversification Ratio is equal to the number of risk factors to which the portfolio has an equal risk exposure. This number is the Anti-Benchmark Number of Degrees of Freedom of the portfolio.

By analogy, for any portfolio that is not necessarily efficient, the square of its Anti-Benchmark Diversification Ratio will measure its Anti-Benchmark Number of Degrees of Freedom, or the effective number of independent risk factors the portfolio has an exposure to. In general, this real number will be an greater than one.

Anti-Benchmark Number of Degrees of Freedom of a Given Universe.

For a given universe, the Anti-Benchmark portfolio will always have the greatest Anti-Benchmark Number of Degrees of Freedom (“N”) across all portfolios, as the Anti-Benchmark also maximizes the square of the diversification ratio.

As the number “N” is unique for any given universe, it is called the Anti-Benchmark Number of Degrees of Freedom of the universe, and a measure the number of independent risk factors available in that universe.

### Selected Effects on an Embodiment of Anti-Benchmark

Small-Cap Effect

Some small cap bias compared to an index is unavoidable because the large cap bias of market cap benchmarks is also a bias for overvalued assets. Anti-Benchmark will not have a linear relationship with small cap beta, however, and will bias securities which are mid-cap as easily as smaller cap within any universe. Large cap securities are avoided if they have a high covariance, but some large caps with lower covariance with the market will be purchased, so we will not necessarily be underweight large caps relative to the benchmark.

Cyclical Factor Effect

Styles and common factors as commonly used by market participants are not explicitly related to Anti-Benchmark, which will avoid companies in a particular style when it is most in fashion, but will do so gradually over time. This leads Anti-Benchmark to have a somewhat anti-momentum bias over periods of less than one year. See, e.g., Arnott/Hsu/Moore 2005.

Valuation Effect

Expected returns seem to be less than linearly related to beta, less so than CAPM would suggest. This is because it is not likely that market cap weighted benchmarks are the most efficient market portfolio. It can also be demonstrated that market capitalization weighted indices will be more likely to overweight overvalued securities, and Anti-Benchmark will not be systematically biased in this way. See, e.g., Black/Jensen/Scholes 1972, Black 1993, Arnott/Hsu/Moore 2005, and Treynor 2005.

### Comparison of an Embodiment of Anti-Benchmark to Other Methods

(1) Index Funds (William Sharpe)

Summary: Based on CAPM, assumption is that in equilibrium, the market portfolio is defined by the market capitalization of the securities in the market.

Advantages: (a) inexpensive; (b) transparent; (c) tax-efficient; and (d) low turnover.

Disadvantages: (a) cap weighting is not the most diversified; (b) tendency to overweight overvalued securities; and (c) the idea that all investors should simultaneously hold the market portfolio is not practical, among numerous theoretical limitations such as unlimited access to leverage and borrowing.

Some differences with Anti-Benchmark: (a) momentum bias relative to Anti-Benchmark; (b) Anti-Benchmark security weights are independent of the weightings by market cap; and (c) index funds are a passive strategy, while Anti-Benchmark is a systematic, quantitatively driven, active strategy.

(2) Index Trackers (Richard C. Grinold & Ronald N. Kahn, Barr Rosenberg)

Summary: Rather than attempt to hold the entire market capitalization benchmark as the market portfolio, it is possible to hold similar but actively chosen biases within risk constraints to the benchmark. If biases are carefully chosen using historical relationships underpinned by commonly held views about valuations and economic relationships, it is possible to construct portfolios with superior reward/risk characteristics than the market portfolio. Index trackers also include unbiased sampling portfolios, designed to mirror the return/risk characteristic of the market portfolio but with significantly fewer required holdings.

Advantages: (a) can improve on the diversification of index funds; (b) often alpha driven, so investors have potential out-performance; and (c) limited risk of underperformance of client benchmarks.

Disadvantages: (a) out-performance is limited by still trying to match the benchmark; and (b) turnover is substantially higher than the index funds, so not as tax efficient.

Some differences with Anti-Benchmark: (a) Anti-Benchmark does not attempt to minimize its tracking error to the index, while index trackers have a specific tracking error goal; and (b) most of the return of the Index trackers is just index related return, while arguably a significant part of the return of the Anti-Benchmark is related to its tracking error to the index (although both are capturing the same market risk premium).

(3) Fundamental Indexes (Robert D. Arnott)

Summary: Measure size by some alternative measure to market capitalization. The portfolios are constructed based on ranking variables such as book value, sales, number of employees, etc.

Advantages: (a) can improve on the diversification of index funds; (b) by design closer to the idea of market capitalization weighting, because the variables used to weight the securities have some correlation with market capitalization, so not much risk is taken relative to conventional indexing; and (c) potential out-performance by being somewhat unrelated to the index benchmark construction.

Disadvantages: (a) the size variables are arbitrary with no real theory as to why they should be better than market cap weightings; (b) large overlap with capitalization weightings so only limited benefit in that regard; and (c) may carry the same biases of active managers.

Some differences with Anti-Benchmark: (a) much higher beta to the market cap indices than Anti-Benchmark, which does a better job of avoiding the market cap weighted benchmark biases while also maintaining a similar return; and (b) diversification is a side-effect of the Fundamental Indexes, while it is the explicit design of the Anti-Benchmark, which should provide much better diversification for a client who holds other core equity strategies.

(4) Diversity Index (Robert Fernholz)

Summary: The method is based on the idea that the market will have a tendency towards diversification, with some random fluctuation in rankings by market capitalization. The diversity index is built with the idea that the rotation within a diversifying market provides a market structure effect which can be exploited to produce portfolios with superior reward to risk characteristics.

Advantages: (a) systematic approach to improve on the diversification of index funds; (b) can be applied with limited tracking error to the index benchmark; (c) not alpha driven, but potential out-performance of index benchmarks; and (d) underperformance compared to the market cap indices can be somewhat limited.

Disadvantages: (a) a small cap bias is explicitly built into the system; and (b) upside is limited by the amount of risk taken relative to the benchmark.

Some differences with Anti-Benchmark: (a) betas of Diversity indexes are generally designed to be close to one, while Anti-Benchmark has no beta target; and (b) Diversity indices are designed not to deviate very much from the index, while Anti-Benchmark is designed to vary as much as possible while still being mean-variance efficient.

### Some Additional Features of Embodiments of Anti-Benchmark

Anti-Benchmark is based on methods where a portfolio may be constructed using historical statistical relationships of past returns (especially covariance relationships) as the primary driver of security selection and weightings. Anti-Benchmark is a portfolio which should be close to mean-variance efficiency, and is designed with the explicit purpose of diversifying an index portfolio and improving the reward to risk of the total benchmark+Anti-Benchmark holdings of an investor.

Anti-Benchmark is a new tool (and perhaps can be considered a distinct asset class) for investors to use for creating a diversifying counterbalance to the index and index tracking methodologies which have become so overwhelmingly popular in the fund management industry.

Anti-Benchmark has substantial tracking error to the index benchmark by design, while all other commonly used portfolio construction methods rely in part on the use of market capitalization in their weightings, therefore by design offering less diversification away from the benchmark.

Some advantages of some embodiments: (a) systematic approach to explicitly improve on the diversification of index and index tracking funds; (b) not alpha driven, but with a potential to out-perform index benchmarks; (c) upside not limited by any particular risk constraints; (d) can be used as a new asset class by asset allocators; and (e) turnover lower than actively managed portfolios.

Some disadvantages of some embodiments: (a) a small cap bias is an inevitable side-effect, albeit not systematically built in like the diversity index; (b) large deviations from the index benchmark over multi-year periods may be beyond the tolerance of some investors.

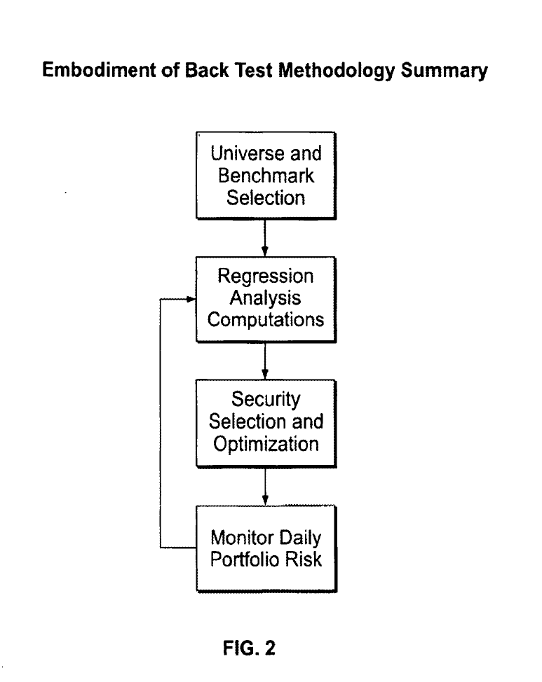

FIG. 2 depicts preferred back test methodology, as discussed above.

### Example

### Lehman Brothers Anti-Benchmark^{SM} Euro Equity Fund

Lehman Bothers Asset Management's Anti-Benchmark strategy is a quantitative long-only beta product. The strategy will have low correlation, and potentially lower volatility and higher Sharpe Ratio compared to standard market cap weighted benchmarks. The product offers the flexibility of being tailored to any investor's benchmark, and can be utilized to increase the Sharpe ratio or decrease the total risk for any investor's long-beta exposure. Combining Anti-Benchmark with an Index Portfolio will provide investors the same risk premium with lower total risk. The fund offers investors a way to increase their diversification using a scalable long-only approach. This product will alleviate some of the pressure to search for scalable diversifying return through non-traditional sources.

Anti-Benchmark is a purely quantitative active portfolio management system. The starting point in our process is an investor universe screened for investibility and for suitability to the model. The system then employs risk characteristics as the sole inputs to the security selection process. Correlation and covariance are utilized to select the securities, and final weightings are determined by optimizing the portfolio using standard portfolio optimization techniques. Optimization is performed on a weekly basis, but actual rebalancing is dependent on the deviation from optimal over time.

Risk management is a central part of our investment process. Investment constraints on the portfolio are built in by setting a maximum level of concentration in any given name. If Merger & Acquisition activity or other market information which is not explicitly handled by our model has a material impact on any of our holdings, it will be dealt with on a case by case basis based on the experience of the investment team.

Positions are monitored on a daily basis. Corporate actions and market information are analyzed for impact on the expected returns, and actions are taken if appropriate based on size of the risk and impact on the overall portfolio. In all cases changes to the portfolio weightings are implemented through optimization of the overall portfolio.

Additional Information about exemplary Back Test: The universe used for the back testing is the EuroStoxx Index, an index made up of 300+ constituents. An initial liquidity screen leaves approximately 150 stocks, based on historic traded volumes. Optimization is used to select and weight securities solely based on historical statistical data, built on rolling multiple years of data. Constraints on maximum exposure per name are imposed: maximum single holding of 5%, and no more than 40% in the largest 10 names. There is no restriction on tracking error, beta, industry, or other common factors. The resulting portfolio is made up of 20-25 names.

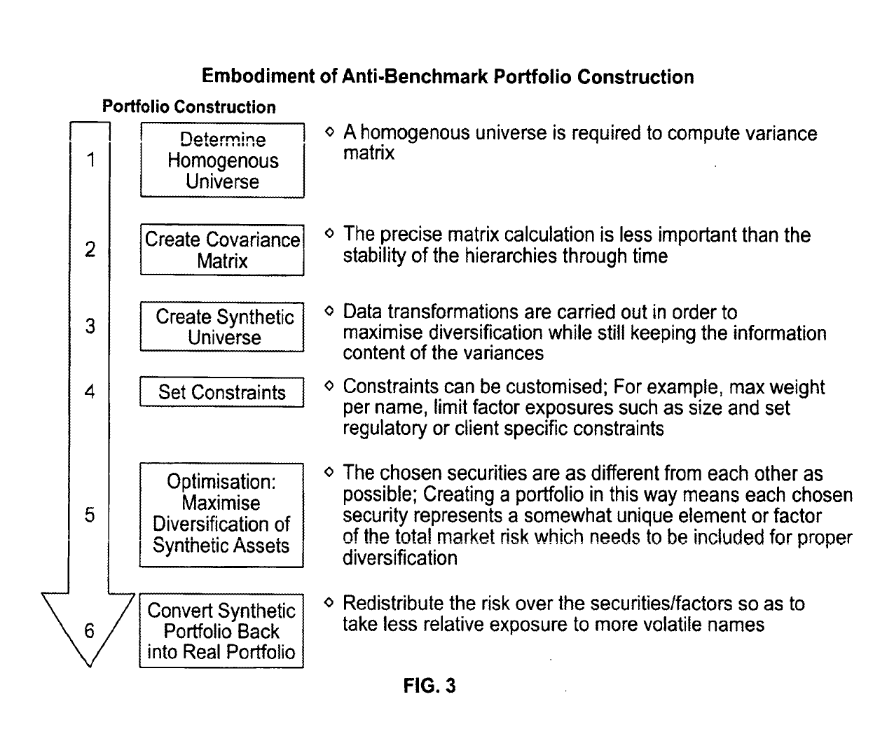

FIG. 3 contains an embodiment of Anti-Benchmark Portfolio Construction.

Summary of Backtest Results
Anti-Benchmark^{SM} provided significant diversification benefits when combined with an index portfolio.
Anti-Benchmark^{SM} exhibited consistently higher Sharpe ratio relative to standard market benchmarks.
Anti-Benchmark^{SM} outperformed over multiple year time horizons.
Testing includes several different investment universes and computational approaches to stress test the theory:
   both narrow and broad indices (EuroStoxx-50, CAC-40, DAX-30, FTSE, Eurostoxx TMI);
   computational methods (Linear Programming, classical Mean-Variance, APT factor model); and
   frequency of Rebalance (annual, monthly, weekly).
Methods employed yielded intuitive results:
   broad indices provided more diversification benefit than narrow;
   all tested computational methods yielded similar results (90% or more correlated); and
   higher frequency yields higher returns, but results persist over less frequent rebalancing.

Performance Expectations
Anti-Benchmark^{SM} targets maximum diversification and the capacity to capture the full market risk premium should not be diluted.
Anti-Benchmark^{SM} will have a low predicted beta to the Benchmark, and should outperform during most periods of weaker markets; our empirical work indicates that beta is a poor predictor or the return of Anti-Benchmark over a market cycle, returns actually exceed the benchmark return over our testing period.
Evidence of outperformance in our backtest results has several potential explanations, among them:
   Market Capitalisation indices are inefficient and biased to being overweight, overvalued securities on average;
   Anti-Benchmark^{SM} is a more efficient portfolio than cap weighted benchmarks due to the attempt in construction to maximise the diversification effect of the portfolio;
   Low beta securities have persistent ex-post return/risk above the theoretical Capital Market Line as predicted by CAPM.

It will be appreciated that the present invention has been described by way of example only and with reference to the accompanying drawings, and that improvements and modifications may be made to the invention without departing from the scope or spirit thereof.

1. A method comprising:
providing a first portfolio comprising a first group of securities; and
creating a second portfolio comprising a second group of securities selected from said first group of securities; wherein
said step of creating a second portfolio comprises performing a step of maximizing a diversification ratio represented by a quotient having as a numerator a measure of a weighted average risk characteristic of the second group of securities and as a denominator a measure of an overall risk characteristic of the second portfolio.

2. A method as in claim 1, wherein said step of maximizing a diversification ratio is based solely on risk characteristics.

3. A method as in claim 1, wherein said measure of a weighted average risk characteristic comprises a product of a row vector of holdings in said second group of securities and a column vector of a risk characteristic of the securities.

4. A method as in claim 1, further comprising a step of combining said second portfolio with said first portfolio, a portion of said first portfolio or an index portfolio.

5. A method as in claim 1, further comprising a step of measuring the number of risk factors to which said first or second portfolio are effectively exposed

6. A non-transitory computer readable medium having a computer program stored thereon which, when executed by a computer processor, performs a method comprising creating a portfolio comprising a group of securities, wherein said step of creating a portfolio comprises performing a step of maximizing a diversification ratio represented by a quotient having as a numerator a measure of a weighted average risk characteristic of the group of securities and as a denominator a measure of an overall risk of the portfolio.

7. A non-transitory computer readable medium as in claim 6, wherein said step of maximizing a diversification ratio is based solely on risk characteristics.

8. A non-transitory computer readable medium as in claim 6, wherein said measure of a weighted average risk characteristic comprises a product of a row vector of holdings in said group of securities and a column vector of a risk characteristic of the securities.

9. A non-transitory computer readable medium as in claim 6, wherein said computer program stored thereon, when executed by a computer processor, further performs a step of combining said portfolio with a first portfolio, a portion of a first portfolio or an index portfolio.

10. A non-transitory computer readable medium as in claim 6, wherein said computer program stored thereon, when executed by a computer processor, further performs a step of measuring the number of risk factors to which said first or second portfolio are effectively exposed.

11. A system comprising:
one or more computer processors, and
a computer program which is executable by said one or more computer processors and which, when executed, performs a method comprising creating a portfolio comprising a group of securities, wherein said step of creating a portfolio comprises performing a step of maximizing a diversification ratio represented by a quotient having as a numerator a measure of a weighted average risk characteristic of the group of securities and as a denominator a measure of an overall risk of the portfolio.

12. A system as in claim 11, wherein said step of maximizing a diversification ratio is based solely on risk characteristics.

13. A system as in claim 11, wherein said measure of a weighted average risk characteristic comprises a product of a row vector of holdings in said group of securities and a column vector of a risk characteristic of the securities.

14. A system as in claim 11, wherein said computer program, when executed, further performs a step of combining said portfolio with a first portfolio, a portion of a first portfolio or an index portfolio.

15. A system as in claim 11, wherein said computer program, when executed, further performs a step of measuring the number of risk factors to which said first or second portfolio are effectively exposed.
